(19) United States
(12) Patent Application Publication
(10) Pub. No.: US 2005/0253849 A1
(43) Pub. Date: Nov. 17, 2005

(54) Custom spline interpolation

(75) Inventors: Martin Reddy, San Francisco, CA (US); Timothy S. Milliron, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pixar, Emeryville, CA (US)

(21) Appl. No.: 11/058,724

(22) Filed: Feb. 14, 2005

Related U.S. Application Data
(60) Provisional application No. 60/571,027, filed on May 13, 2004.

(51) Int. Cl. G06T 15/70; G06T 13/00

(52) U.S. Cl. 345/473

(57) ABSTRACT

User-defined interpolation modules can be associated with animation variables in an animation system. Interpolation modules determine the values of animation variables at a given time. Interpolation modules can perform any arbitrary type of calculation, evaluation, simulation, or other data manipulation using the knots of one or more animation variables and/or other data to determine the value of one or more animation variables at the desired evaluation time. Interpolation modules can preserve their current state and retrieve previous states, enabling the use data from previous executions of the interpolation module to determine the current values of animation variables. Interpolation modules can be written in any programming or scripting language and can be dynamically loaded by the animation system as needed. The interpolation module can define any arbitrary relationship between animation variables. Interpolation modules can add knots to an animation variable at any arbitrary time.

### CROSS-REFERENCES TO RELATED APPLICATIONS

This application claims benefit under 35 U.S.C. 119(e) to U.S. Provisional Patent Application No. 60/571,027, filed May 13, 2004, which is incorporated by reference herein for all purposes.

### BACKGROUND OF THE INVENTION

The present invention relates to the field of computer graphics, and in particular to methods and apparatus for animating computer generated objects. Many computer graphic images are created by mathematically modeling the interaction of light with a three dimensional scene from a given viewpoint. This process, called rendering, generates a two-dimensional image of the scene from the given viewpoint, and is analogous to taking a photograph of a real-world scene. Animated sequences can be created by rendering a sequence of images of a scene as the scene is gradually changed over time. A great deal of effort has been devoted to making realistic looking rendered images and animations.

In computer-generated animation, an object's appearance is defined by a three-dimensional computer model. To appear realistic, the computer model of an object is often extremely complex, having millions of surfaces and tens of thousands of attributes. Due to the complexity involved with animating such complex models, particularly character models with hundreds or thousands of degrees of freedom, animation tools often rely on animation variables to define the animation of objects.

Animation variables, which are sometimes referred to as avars, are parameters used by functions to modify the position, or pose, of all or a portion of a model. Animation variables and their associated functions can specify relatively simple motions, such as the translation and rotation of objects. Animation variables and their associated functions are also used to abstract complicated modifications to a model to a relatively simple control. For example, animation variables can specify the rotation angles of the joints of a character model, thereby positioning the character model's limbs and appendages. More complicated animation variables can define the degree of opening of a character's mouth. In this example, the value of the animation variable is used to determine the position of the many different parts of the character model needed to open the characters mouth to the desired degree. The animation tools then modify the character model according to the final posed armature to create a character model with an open mouth.

Animators define animated sequences by specifying the values of animation variables of an object, and hence the pose of an object, at one or more key frames. A pair of an animation variable value and its associated time value is referred to as a knot. The animation system determines the pose of an object in the frames between key frames by interpolating the values of its avars from the knots. A variety of different interpolation schemes are used in animation, including linear, cubic, b-spline, Bezier, and Catmull-Rom. Different interpolation schemes often result in a radically different appearance of motion of the object between knots. Thus, it is desirable for the interpolation scheme to closely match the characteristics of the object's intended motion.

However, objects sometimes need to move in ways greatly different than that defined by standard interpolation schemes. For example, the path of a car driving between two knots will depend on factors such the position, size, and orientation of its wheels in addition to its initial and final poses. To emulate particular camera systems, such as steadicams, the camera path must behave in a specific manner. Unlike standard interpolation schemes that interpolate each animation variable independently, some types of object motion specify a dependence between multiple animation variables.

It is therefore desirable for a system and method to enable any arbitrary interpolation scheme for animation variables. It is also desirable for the system and method to interpolate groups of interdependent animation variables. It is further desirable for the animation system to allow the value of a master animation variable to affect the interpolation of one or more slave avars. It is still further desirable for the system and method to seamlessly integrate arbitrary interpolation schemes and to apply these interpolation schemes with minimal performance penalty.

### BRIEF SUMMARY OF THE INVENTION

An embodiment of the invention enables animation variables to be associated with user-defined interpolation modules. Interpolation modules determine the values of animation variables at a given time. Interpolation modules can perform any arbitrary type of calculation, evaluation, simulation, or other data manipulation using the knots of one or more animation variables and/or other data to determine the value of one or more animation variables at the desired evaluation time. Interpolation modules can preserve their current state and retrieve previous states, enabling the use data from previous executions of the interpolation module to determine the current values of animation variables. Interpolation modules can be written in any programming or scripting language and can be dynamically loaded by the animation system as needed. The interpolation module can define any arbitrary relationship between animation variables. Interpolation modules can add knots to an animation variable at any arbitrary time.

In an embodiment, a method of determining the value of a first animation variable at a first specified time includes determining the value of the first animation variable by interpolating from the value of at least one knot associated with the first animation variable if the first animation variable is not associated with a user-defined interpolation module. If the first animation variable is associated with the user-defined interpolation module and the user-defined interpolation module has not been previously loaded, the method locates, loads, and initializes the user-defined interpolation module. If the first animation variable is associated with the user-defined interpolation module, the animation system determines the value of the first animation variable by invoking a function of the user-defined interpolation module. The function of the user-defined interpolation module is adapted to return the value of the first animation variable at the first specified time.

In a further embodiment, invoking the function of the user-defined interpolation module includes communicating at least one knot associated with the first animation variable with the user-defined interpolation module. Invoking the function of the user-defined interpolation module may include communicating at least one knot associated with a second animation variable with the user-defined interpolation module. The user-defined interpolation module may be adapted to return the value of a second animation variable at the first specified time. In another embodiment, the user-defined interpolation module may be adapted to return a knot associated with the first animation variable. The knot may include a time value determined by the user-defined interpolation module.

In yet another embodiment, the user-defined interpolation module may be adapted to invoke another user-defined interpolation module to determine the value of the first animation variable or a second animation variable associated with the first animation variable. In still another embodiment, the user-defined interpolation module may be adapted to invoke a default interpolation scheme to determine the value of the first animation variable or a second animation variable associated with the first animation variable.

In an additional embodiment, the user-defined interpolation module may be adapted to use data from a previous invocation of the function to determine the value of the first animation variable. In an embodiment, the user-defined interpolation module may be adapted to store data to be used to determine the value of the first animation variable for a subsequent invocation of the function.

### BRIEF DESCRIPTION OF THE DRAWINGS

The invention will be described with reference to the drawings, in which:

FIG. 1 illustrates an example computer system capable of implementing an embodiment of the invention;

FIG. 2 is a flowchart illustrating a method of creating an interpolation module and animating an object with the interpolation module according to an embodiment of the invention;

FIG. 3 is a flowchart illustrating a method of evaluating an animation variable with an interpolation module according to an embodiment of the invention; and

FIG. 4 illustrates an example relationship between animation variables and an interpolation module according to an embodiment of the invention.

### DETAILED DESCRIPTION OF THE INVENTION

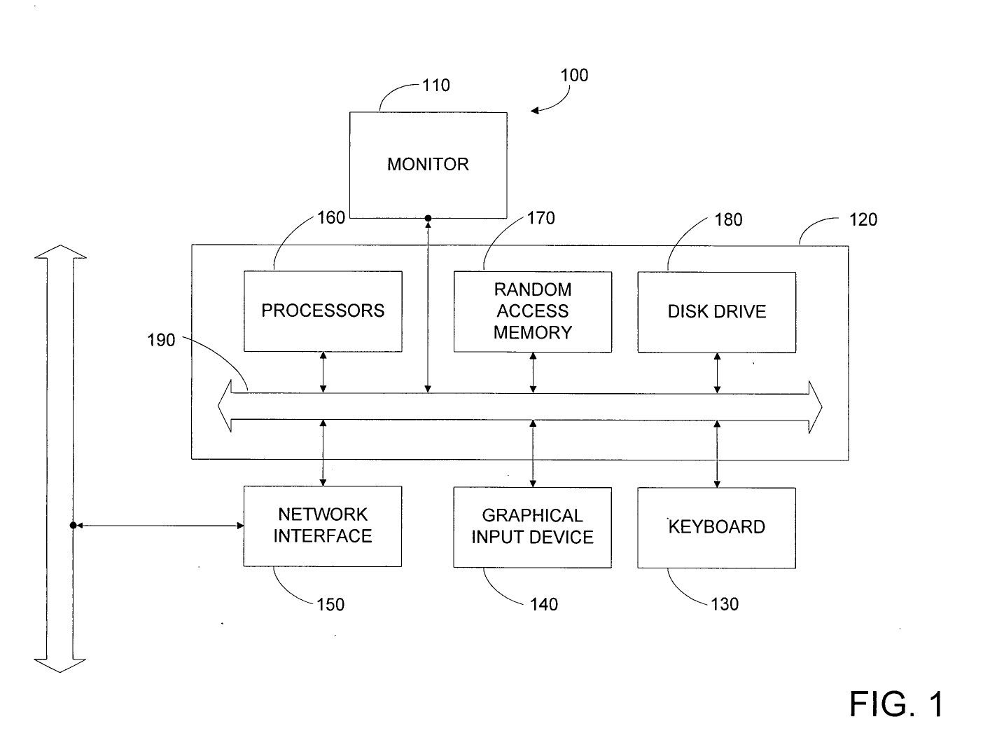

FIG. 1 illustrates an example computer system 100 capable of implementing an embodiment of the invention. Computer system 100 typically includes a monitor 110, computer 120, a keyboard 130, a user input device 140, and a network interface 150. User input device 140 includes a computer mouse, a trackball, a track pad, graphics tablet, touch screen, and/or other wired or wireless input devices that allow a user to create or select graphics, objects, icons, and/or text appearing on the monitor 110. Embodiments of network interface 150 typically provides wired or wireless communication with an electronic communications network, such as a local area network, a wide area network, for example the Internet, and/or virtual networks, for example a virtual private network (VPN).

Computer 120 typically includes components such as one or more general purpose processors 160, and memory storage devices, such as a random access memory (RAM) 170, disk drives 180, and system bus 190 interconnecting the above components. RAM 170 and disk drive 180 are examples of tangible media for storage of data, audio/video files, computer programs, applet interpreters or compilers, virtual machines, embodiments of the herein described invention including geometric scene data, object data files, shader descriptors, a rendering engine, output image files, texture maps, and displacement maps. Further embodiments of computer 120 can include specialized audio and video subsystems for processing and outputting audio and graphics data. Other types of tangible media include floppy disks; removable hard disks; optical storage media such as DVD-ROM, CD-ROM, and bar codes; non-volatile memory devices such as flash memories; read-only-memories (ROMS); battery-backed volatile memories; and networked storage devices.

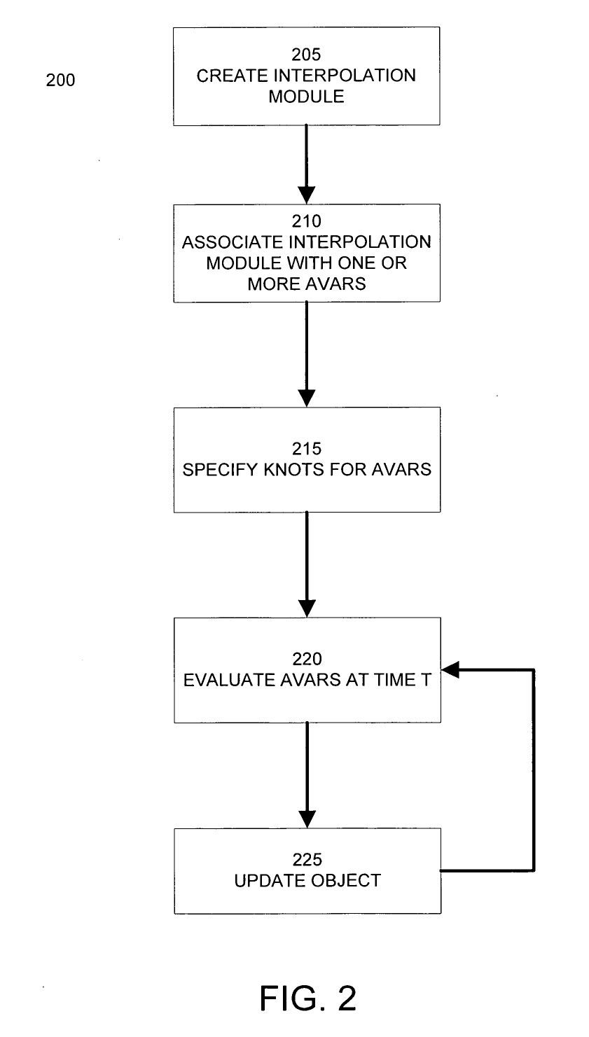

FIG. 2 is a flowchart 200 illustrating a method of creating an interpolation module and animating an object with the interpolation module according to an embodiment of the invention. At step 205, a custom interpolation module is created. Interpolation modules can be written in any programming or scripting language, such as the C programming language. In an embodiment, interpolation modules interface with the animation system using an application programming interface (API) provided by the animation system. The API specifies one or more callback functions to be included in an interpolation module that can be adapted to be invoked by the animation system.

In an embodiment, the interpolation module includes an interpolation callback function that receives one or more animation variables and a desired evaluation time from the animation system and returns the value of one or more animation variable values at the evaluation time. During the invocation of this function, the animation system communicates one or more knots for each animation variable required by the interpolation module to determine the value of an animation variable at the evaluation time. The interpolation callback function can perform any arbitrary type of calculation, evaluation, simulation, or other data manipulation using the knots of one or more animation variables and/or other data to determine the value of one or more animation variables at the desired evaluation time. Moreover, the interpolation callback function can use the knots of one or more animation variables to determine the values of one or more animation variables. Additionally, the interpolation module can preserve its current state and retrieve a previous state from a prior invocation, enabling the callback function to use data from previous interpolation callback function invocation to determine the current value of an animation variable.

In an additional embodiment, the interpolation module can include different interpolation callback functions for different data types, such as string and float data types. In this embodiment, animation variables have a string value would be evaluated by one type of callback function while animation variables having a floating point number value would be evaluated by another type of callback function. In another embodiment, the interpolation callback function call invoke a function of another interpolation module or the default interpolation scheme of the animation system. For example, a car motion interpolation module could move an object like a wheeled vehicle when an animation variable has a value of “ON” and use the animation system's default interpolation scheme to move the object when the same animation variable has a value of “OFF.”

In a further embodiment, the API enables an interpolation module to include additional callback functions for accessing information about one or more animation variables. One example of an additional callback function is a query callback function. The query callback function enables the animation system to query the interpolation module about its current state or behavior. Another example of an additional callback function is a delete animation variable callback function. Because animation variables associated with an interpolation module can be interdependent, the interpolation module can include a callback function that specifies which additional animation variables can be safely deleted when the animation system wishes to delete a given animation variable. The interpolation module can include similar callback functions for copying, moving, and/or modifying animation variables or knots of animation variables. In an embodiment, the developer of the interpolation module must define all of the callback functions available in the animation system. In an alternative embodiment, default callback functions are automatically defined for each interpolation module. These default callback functions can be overridden by the interpolation module developer if necessary.

Following the specification of one or more callback functions for an interpolation module, the interpolation module developer adds the interpolation module to the animation system. In an embodiment, an interpolation module is added to the animation system by placing an executable form of the interpolation module in a predetermined file directory or search path. In a further embodiment, the interpolation module is compiled and linked to create an executable form. In a further embodiment, interpolation modules are compiled so that they can be dynamically loaded by the animation system as needed, for example using standard operating system dynamic loading and linking mechanisms such as the Unix dlopen( ).

Step 210 associates the interpolation module with one or more animation variables of an object. In an embodiment, a set of animation variables are defined for an object. For each animation variable, an interpolation scheme is specified. To utilize an interpolation module to interpolate an animation variable, rather than the animation system's standard interpolation schemes, the animation variable definition includes a reference to the interpolation module. In an embodiment, the reference to the interpolation module is the name of the interpolation module.

In a further embodiment, a set of animation variables can be grouped together into an interpolation group. This informs the animation system that the set of animation variables are interdependent and can modify each other. Additionally, the interpolation group specification can indicate a mapping of one or more animation variables associated with an object to corresponding input parameters of the interpolation module. Table 1 lists an example interpolation group specification.

TABLE 1
Example Interpolation Group Specification

object “interp” {

avar A;
avar B;
avar C;
avar D;
defineinterpolant(“Foo”, list (“FooInput1”, “A”,“FooInput2”,
“B”,“FooInput3”, “C”)

}

The example interpolation group specification of Table 1 associates a set of animation variables of an object with the example interpolation module “Foo.” In this example, the animation variables “A,” “B,” and “C” are mapped to the interpolation module inputs “FooInput1,” “FooInput2,” and “FooInput3,” respectively. Animation variable “D” is not assigned to the interpolation module “Foo” and will be interpolated using the animation system's default interpolation scheme.

In step 215, sets of knots are defined for the animation variables associated with an object. The sets of knots specify the values of the animation variables over time, thereby defining the animation of the object. Knots can be specified by an animator, by a simulation, by kinematic solvers, and/or any other animation technique. As discussed in detail below, an interpolation module can add or modify the knots of animation variables.

Typically, the sets of knots define the values of animation variable at one or more key frames. The animation system determines the pose of an object in the frames between key frames by interpolating the values of its animation variables from the knots. In step 220, the animation system determines the value of the animation variables at an arbitrary time t by interpolating from the values of the sets of knots. As discussed in detail below, step 220 can use the animation system's default interpolation scheme and number of interpolation modules to determine the values of the animation variables at time t. In an embodiment, step 220 is used to create preview animations for an animator and to create the final rendered image.

Following step 220, step 225 the shape and/or position of the object using the values of the animation variables determined in step 220. In an embodiment, animation variables are each associated with one or more functions or deformers. These deformers transform animation variable values into values specifying the positions and orientations of control points, which define the shape and/or position of an object. The posed object can then be rendered or otherwise processed to create a frame of animation at time t. Steps 220 and 255 can be repeated to evaluate animation variables at additional arbitrary times.

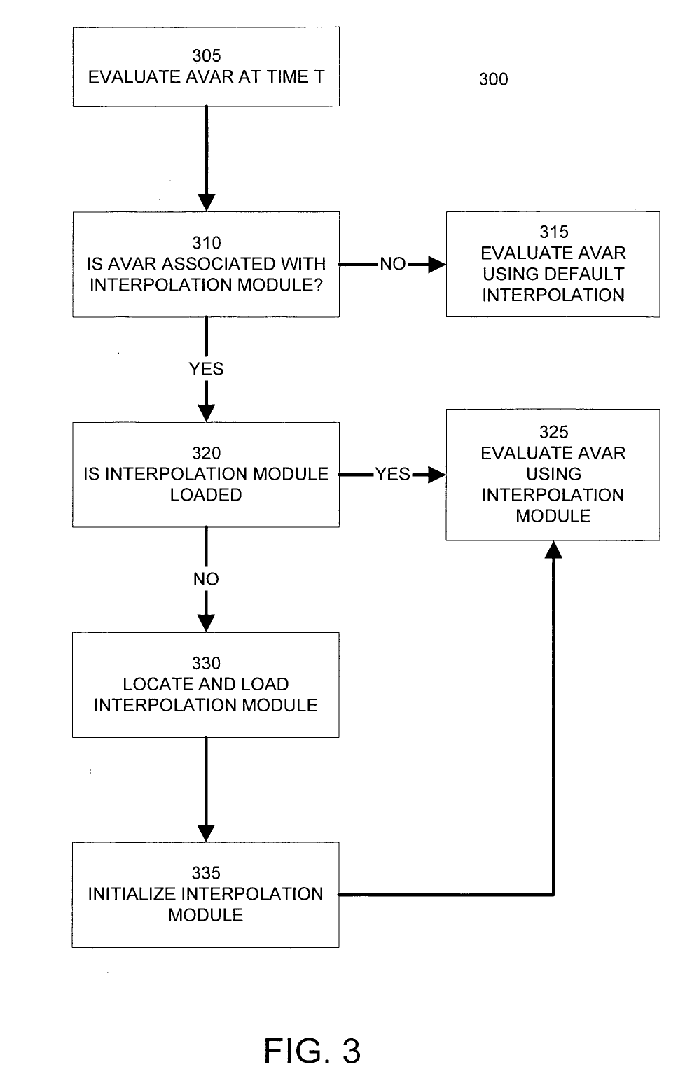

FIG. 3 is a flowchart 300 illustrating a method of evaluating an animation variable with an interpolation module according to an embodiment of the invention. At step 305, the animation system is instructed to evaluate a given animation variable at a specific time. In an embodiment, step 305 is performed by the animation system during step 220 described above.

At step 310, the animation system determines if the animation variable is associated with an interpolation module or with a default interpolation scheme. In an embodiment, an animation specification specifies the sets of knots for the animation variables in an animated sequence and the interpolation module or modules used to evaluate these animation variables. If the animation variable specified in step 305 is not associated with an interpolation module, an embodiment of the animation system proceeds to step 315 and evaluates the specified animation variable using the default interpolation scheme.

Alternatively, if the specified animation variable is associated with an interpolation module, step 320 determines if the required interpolation module has been loaded by the animation system. In an embodiment, the animation specification identifies interpolation modules by name. Step 320 can compare the name of the interpolation module in the animation specification with a list of names of previously loaded interpolation modules to determine if the interpolation module required by the specified animation variable has been loaded.

If step 320 determines that the required interpolation module has been loaded by the animation system, step 325 evaluates the animation variable at the specified time using the interpolation module. In an embodiment, step 325 invokes the interpolation callback function of the interpolation module to evaluate the animation variable. In a further embodiment, step 325 passes to the interpolation callback function at least a portion of the set of knots of each animation variable mapped to a parameter of the interpolation module. As discussed above, the interpolation callback function can perform any arbitrary type of calculation, evaluation, simulation, or other data manipulation using the knots of one or more animation variables and/or other data to determine the value of the specified animation variable at the desired evaluation time. In a further embodiment, if the specified animation variable is part of an interpolation group, the interpolation callback function can determine the values of any other animation variables in the same interpolation group.

In another embodiment, the interpolation callback function can add, remove, or modify knots associated with the specified animation variable and/or any other animation variable in the same interpolation group. This feature enables the interpolation module to implement floating poses for an object. A floating pose specifies a pose, for example the position and/or shape of an object, but does not specify the precise time at which the object should assume this pose. For example, an animator can specify that an object should pass through a specific position at some time on its path between two points. To evaluate a floating pose for an animation variable, an embodiment of an interpolation module evaluates at least two adjacent non-floating knots of the animation variable and determines the optimal time for the animation variable to assume the value specified by the floating pose. The interpolation module then adds a knot specifying the floating pose position and its associated time to the set of knots of the animation variable. If set of knots of this animation variable is later altered, the interpolation module can modify the knot associated with the floating pose accordingly.

Step 325 returns the value of the specified animation variable at the specified time to the animation system. In a further embodiment, if the interpolation module has altered the value of any other animation variables, such as animation variables in the same interpolation group, step 325 sends a message to the animation system to inform it that these other animation variables have been changed.

If step 320 determines that the interpolation module required to evaluate the specified animation variable has not been loaded, step 330 locates and loads the required interpolation module. In an embodiment, step 330 searches for an executable version of the interpolation module by name within a predefined search path. If the interpolation module cannot be located, step 330 sends an error message to the animation system. If step 330 locates the interpolation module, step 330 loads the interpolation module so that the animation system can invoke the callback function of the interpolation module. In an embodiment, the animation system uses a standard operating system dynamic loading and linking mechanism such as Unix dlopen( ).

Following the loading of the interpolation module in step 330, step 335 initializes the interpolation module. In an embodiment, step 335 initializes the interpolation module by invoking an initialization callback. An embodiment of the initialization callback initializes any data used by the interpolation module to evaluate animation variables. In a further embodiment, the initialization callback informs the animation system of the animation variables used and/or affected by the interpolation module. In yet an additional embodiment, the initialization callback also provides the animation system with information about the dependencies between animation variables associated with interpolation module. The animation system can use this information to optimize its performance. For example, if an interpolation group associated with an interpolation module includes a master animation variable that affects the values of a set of slave animation variables, but the slave animation variables do not affect each other, the animation system knows it does not have to update all of the slave animation variables when one slave animation variable is changed.

Following the initialization of the interpolation module in step 335, step 325 can be used to determine the value of the specified animation variable and any additional animation variables as described above.

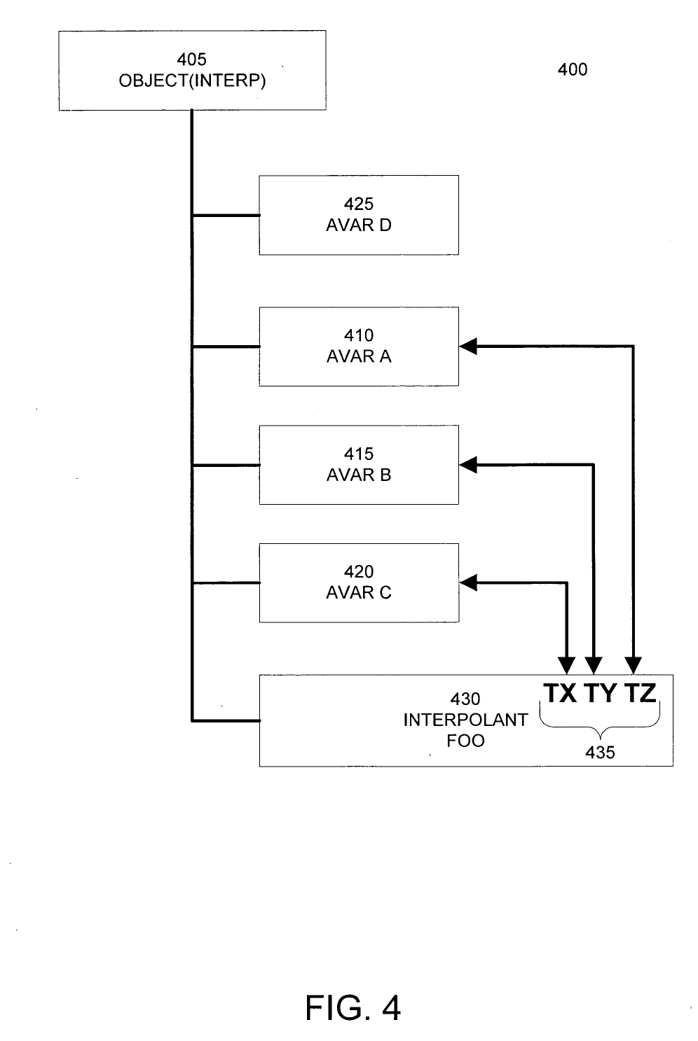

FIG. 4 illustrates an example relationship 400 between animation variables and an interpolation module according to an embodiment of the invention. Interpolation group 405 includes animation variables “A,” 410; “B,” 415; “C,” 420; and “D,” 425. Animation variables “A,” 410; “B,” 415; and “C,” 420 are mapped to a set of inputs 435 of interpolation module 430. Animation variable “D,” 425 is interpolated using the animation system's default interpolation scheme.

The interpolation module 430 can define any arbitrary relationship between its associated animation variables. For example, animation variable “A,” 410 can be a master animation variable that affects the value of animation variables “B,” 415; and “C,” 420. In another example, the values of any of these three animation variables can be affected by the values of the other two animation variables. In a further embodiment, an animation variable can be included in two or more interpolation groups. For example, a single master animation variable can be associated with two different sets of slave animation variables, each associated, for example, with a different interpolation module. In an additional example, animation variables can be associated with multiple interpolation modules in a dependency tree, where an animation variable affected by one interpolation module is used as an input by another interpolation module to affect additional animation variables.

Further embodiments can be envisioned to one of ordinary skill in the art from reading this application. Interpolation modules can be used to implement a wide variety of different motions for objects. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method of determining the value of a first animation variable at a first specified time, the method comprising:
determining the value of the first animation variable by interpolating from the value of at least one knot associated with the first animation variable if the first animation variable is not associated with a user-defined interpolation module;
locating, loading, and initializing the user-defined interpolation module if the first animation variable is associated with the user-defined interpolation module and the user-defined interpolation module has not been previously loaded; and
determining the value of the first animation variable by invoking a function of the user-defined interpolation module if the first animation variable is associated with the user-defined interpolation module, wherein the function of the user-defined interpolation module is adapted to return the value of the first animation variable at the first specified time.

2. The method of claim 1, wherein invoking the function of the user-defined interpolation module includes communicating at least one knot associated with the first animation variable with the user-defined interpolation module.

3. The method of claim 2, wherein invoking the function of the user-defined interpolation module includes communicating at least one knot associated with a second animation variable with the user-defined interpolation module.

4. The method of claim 1, wherein the user-defined interpolation module is adapted to return the value of a second animation variable at the first specified time.

5. The method of claim 1, wherein the user-defined interpolation module is adapted to return a knot associated with the first animation variable, wherein the knot includes a time value determined by the user-defined interpolation module.

6. The method of claim 1, wherein the user-defined interpolation module is adapted to invoke another user-defined interpolation module to determine the value of the first animation variable or a second animation variable associated with the first animation variable.

7. The method of claim 1, wherein the user-defined interpolation module is adapted to invoke a default interpolation scheme to determine the value of the first animation variable or a second animation variable associated with the first animation variable.

8. The method of claim 1, wherein the user-defined interpolation module is adapted to use data from a previous invocation of the function to determine the value of the first animation variable.

9. The method of claim 1, wherein the user-defined interpolation module is adapted to store data to be used to determine the value of the first animation variable for a subsequent invocation of the function.

10. The method of claim 1, wherein loading the user-defined interpolation module includes using a dynamic linking system to provide access to the user-defined interpolation module.

11. A user-defined interpolation module adapted to be dynamically loaded by an animation system, comprising:
an interpolation function adapted to determine the value of a first animation variable at a specified time from at least one associated knot and to return the value of the first animation variable at the specified time, wherein the interpolation function is adapted to receive the associated knot and the specified time from the animation system.

12. The user-defined interpolation module of claim 11, wherein the interpolation function is further adapted to receive at least one knot associated with a second animation variable from the animation system and to determine the value of a first animation variable at a specified time from the associated knot of the second animation variable.

13. The user-defined interpolation module of claim 11, wherein the interpolation function is adapted to determine the value of a second animation variable at the specified time from the first animation variable and to return the value of a second animation variable to the animation system.

14. The user-defined interpolation module of claim 11, wherein the interpolation function is adapted to determine a time value for a knot and to return the knot to the animation system.

15. The user-defined interpolation module of claim 11, wherein the interpolation function is adapted to invoke another user-defined interpolation module to determine the value of the first animation variable or a second animation variable associated with the first animation variable.

16. The user-defined interpolation module of claim 11, wherein the interpolation function is adapted to use data from a previous invocation of the function to determine the value of the first animation variable.

17. The user-defined interpolation module of claim 11, wherein the interpolation function is adapted to store data to be used to determine the value of the first animation variable for a subsequent invocation of the function.

18. The user-defined interpolation module, further comprising:
a query function adapted to identify a set of animation variables associated with the first animation variable.

19. The user-defined interpolation module, further comprising:
a delete function adapted to identify a set of animation variables that should be deleted in conjunction with the first animation variable.

20. An information storage medium including a set of instructions adapted to direct an information processing device to perform an operation comprising:
determining the value of the first animation variable by interpolating from the value of at least one knot associated with the first animation variable if the first animation variable is not associated with a user-defined interpolation module;
locating, loading, and initializing the user-defined interpolation module if the first animation variable is associated with the user-defined interpolation module and the user-defined interpolation module has not been previously loaded; and
determining the value of the first animation variable by invoking a function of the user-defined interpolation module if the first animation variable is associated with the user-defined interpolation module, wherein the function of the user-defined interpolation module is adapted to return the value of the first animation variable at the first specified time.

21. The information storage medium of claim 20, wherein invoking the function of the user-defined interpolation module includes communicating at least one knot associated with the first animation variable with the user-defined interpolation module.

22. The information storage medium of claim 21, wherein invoking the function of the user-defined interpolation module includes communicating at least one knot associated with a second animation variable with the user-defined interpolation module.

23. The information storage medium of claim 20, wherein the user-defined interpolation module is adapted to return the value of a second animation variable at the first specified time.

24. The information storage medium of claim 20, wherein the user-defined interpolation module is adapted to return a knot associated with the first animation variable, wherein the knot includes a time value determined by the user-defined interpolation module.

25. The information storage medium of claim 20, wherein the user-defined interpolation module is adapted to invoke another user-defined interpolation module to determine the value of the first animation variable or a second animation variable associated with the first animation variable.

26. The information storage medium of claim 20, wherein the user-defined interpolation module is adapted to invoke a default interpolation scheme to determine the value of the first animation variable or a second animation variable associated with the first animation variable.

27. The information storage medium of claim 20, wherein the user-defined interpolation module is adapted to use data from a previous invocation of the function to determine the value of the first animation variable.

28. The information storage medium of claim 20, wherein the user-defined interpolation module is adapted to store data to be used to determine the value of the first animation variable for a subsequent invocation of the function.

29. The information storage medium of claim 20, wherein loading the user-defined interpolation module includes using a dynamic linking system to provide access to the user-defined interpolation module.

30. A tangible media including a first image having an object in a first pose, wherein the object is posed according to the method of claim 1.
